(19) United States
(12) Patent Application Publication
(10) Pub. No.: US 2024/0190049 A1
(43) Pub. Date: Jun. 13, 2024

(54) Fluidic Infiltrative Assemblies of Three-Dimensional Hydrogels

(71) Applicant: The Regents of the University of California, Oakland, CA (US)

(72) Inventors: Peter Tseng, Irvine, CA (US); Alberto Ranier Escobar, Irvine, CA (US); Somayeh Zanganeh, Irvine, CA (US)

(21) Appl. No.: 18/286,129

(22) PCT Filed: Apr. 8, 2022
(86) PCT No.: PCT/US22/23957

§ 371 Date: Oct. 8, 2023

Related U.S. Application Data
(60) Provisional application No. 63/172,897, filed on Apr. 9, 2021.

(51) Int. Cl. B29C 33/52; B29C 33/38; B29C 33/40; B29K 33/00; B29K 55/02; B29K 105/00; B33Y 80/00

(52) U.S. Cl. CPC B29C 33/52; B29C 33/40; B33Y 80/00; B29C 33/3842; B29K 2033/26; B29K 2055/02; B29K 2105/0061; B29K 2855/02

(57) ABSTRACT

Fluidic infiltrative assemblies of 3D hydrogel with heterogeneous compositions and functions in accordance with embodiments of the invention are disclosed. In one embodiment, a method for generating three-dimensional (3D) hydrogels is provided, the method comprising: generating a fluidic mold; infiltrating the fluidic mold with a precursor solution; gelatinizing the precursor solution; and degrading the fluidic mold in a degradation solution to release a 3D hydrogel.

### CROSS-REFERENCE TO RELATED APPLICATION

The current application claims priority to U.S. Provisional Patent Application No. 63/172,897 filed on Apr. 9, 2021, the disclosure of which is incorporated herein by reference.

### FIELD OF THE INVENTION

The present invention generally relates to three-dimensional (3D) printing and more specifically to fluidic infiltrative assemblies of 3D hydrogels with heterogeneous compositions and functions.

### BACKGROUND

Three-dimensional (3D) printing methods may broadly be classified based on their working principle (e.g., extrusion-based, droplet-based, or laser-based) and may be the primary limiter in determining hydrogel printability. Extrusion-based printing (EBP) methods are amongst the most common as they offer great printing speed, facilitate scalability, and may be capable of creating anatomically correct porous constructs. However, they may offer limited resolution and necessitate the use of quick-gelling, shear-thinning hydrogel precursor solutions. Droplet-based printing (DBP) offers greater resolution than EBP and may be capable of generating 3D hydrogels with controlled, local heterogeneity at the expense of mechanical strength and built-in porosity. Laser-based printing (LBP) offers the greatest resolution of the three methods and may be capable of creating porous constructs like EBP. However, resin constituents for LBP must have quick cure times, low viscosities, and must be directly photopolymerizable.

Further, limitations to hydrogel printability are some of the major constraints that slowed the application of hydrogel materials. In addition, to date, few of these strategies have demonstrated the robust capability to produce complex, free-standing, multi-material constructs that possess desired heterogeneity for next generation hydrogel structures/systems.

### SUMMARY OF THE INVENTION

The various embodiments of the present fluidic infiltrative assemblies of 3D hydrogels with heterogeneous compositions and functions contain several features, no single one of which is solely responsible for their desirable attributes. Without limiting the scope of the present embodiments, their more prominent features will now be discussed below. In particular, the present fluidic infiltrative assemblies will be discussed in the context of 3D hydrogels with heterogeneous compositions and functions. However, the use of 3D hydrogels are merely exemplary and various other materials may be utilized for fluidic infiltrative assemblies as appropriate to the requirements of a specific application in accordance with various embodiments of the invention. Further, the use of particular hydrogels with heterogeneous compositions and/or functions are also merely exemplary and various other hydrogels with various compositions and/or functions may be utilized as appropriate to the requirements of a specific application in accordance with various embodiments of the invention. After considering this discussion, and particularly after reading the section entitled “Detailed Description,” one will understand how the features of the present embodiments provide the advantages described here.

One aspect of the present embodiments includes the realization that 3D hydrogels have garnered significant attention across a variety of engineering disciplines for their potential applications in next-generation systems. Generally, hydrogels (may also be referred to as “gels”) are highly hydrophilic, 3D-polymer networks of natural and/or synthetic origin. The base-level functionality of the gel may be dependent on the chemical characteristics of the polymer backbone. The built-in hydrophilicity of hydrogels often imparts biocompatibility and sometimes biomimicry which, when coupled with tunable mechanical properties, make them prime material candidates for emerging systems in tissue engineering, soft robotics, or biosensing. There is tremendous diversity to the structure of hydrogels and their constituent components which may be crosslinked through chemical or physical strategies, potentially including biomolecules and/or nanomaterials. Further, modern hydrogels may be doped with biomolecules and/or nanomaterials. Tunable control over the gelation and constituents of hydrogels enable these materials to have a large degree of programmability in behavior and such mutability lends a material versatility that may be unseen in other biocompatible materials. Although potential methods have been proposed to print (or pattern) hydrogels, such methods lack the ability to machine a broad spectrum of existing hydrogels and modifiers in 3D.

Another aspect of the present embodiments includes the realization that an alternative to direct 3D printing methods may include sacrificial templating mediated by 3D printed templates. Instead of using 3D printing to directly define the hydrogels geometry, this method relies on 3D printing to create dissolvable structures that may impart high resolution features to 3D hydrogels while also capitalizing on the use of negative space. For structures with complex internal structures, a template may be 3D printed with a dissolvable material (e.g., wax, sugar, polyvinyl alcohol (PVA), etc.) and is typically then encased in elastomer or hydrogel. After dissolution of the template, the resulting structure may contain a complex, high resolution internal architecture. Structures that are complex both internally and externally may be made by creating a 3D printed, reverse template of the desired structure, filling void space with the hydrogel, and dissolving the template. This strategy has primarily been utilized to create tissue-mimicking gels with engineered perfusion. A primary advantage of this strategy is that it is potentially compatible with any hydrogel that is gelled in-situ which encompasses a large percentage of existing hydrogel synthesis protocols.

As further described below, the present embodiments combine sacrificial structuring of hydrogels with coordinated injection molding strategies to bypass various constraints placed on hydrogel material selection and printability that are associated with traditional, direct hydrogel 3D printing strategies. In many embodiments, sacrificial fluidic molds may be 3D printed at micro-scale resolution using a commercially available stereolithography (SLA) 3D printer and available resins. In various embodiments, through defined inlets/outlets, these molds may be filled with a selection of natural, synthetic and/or “smart” hydrogel precursor solutions while being doped with large concentrations of nanomaterials or biomolecules. In several embodiments, after complete gelation (via standard chemical or physical crosslinking techniques), the sacrificial molds may be degraded in a solution (e.g., a fluoroalcohol solution) thereby releasing the hydrogel with minimal to no change of its basic physical behavior. As further described below, programmable control over the infiltration of the hydrogel precursor solutions into various inlets may allow for the creation of multi-material, multi-functional hydrogels with flow-defined heterogeneity. The present embodiments may allow for a versatility that is typically inaccessible to direct printing such as, but not limited to: (1) printing process is highly accessible and achieved using commercially available printer such as, but not limited to, a 3D SLA printer and resin, (2) both basic and interpenetrating networks of synthetic and biologically-derived polymers may be readily synthesized (crosslinked via either chemical or physical means), (3) allows generally unconstrained doping of nanomaterials and biomolecules, (4) enables facile generation of heterogeneous material with tunable gradients, and (5) unique architectures may be synthesized, driven via the engineering of fluidic operations in a 3D shell (particle sorting, mixing, and sheath flow demonstrated herein for example). In a variety of embodiments, the hydrogel structuring/gelation and primary sacrificial processes may be rapid and may potentially be completed within minutes. For illustrative purposes, the present embodiments demonstrate a variety of complex, 3D multi-material hydrogel systems with programmable function (e.g., motion/mechanics, temperature/light interactivity, gradient behavior) in 3D. One of ordinary skill in the art would appreciate that the present embodiments may be readily adaptable to a large variety of existing hydrogel formulations without additional engineering. For example, the prepolymer may no longer need to be adapted to the 3D printing technique; the polymer may simply need to be able to be capable of in-situ gelation and remain functional under short exposure to a solvent, which many hydrogels are capable of, thus enabling a diverse set of protocols from various processes.

### BRIEF DESCRIPTION OF THE DRAWINGS

The various embodiments of the present fluidic infiltrative assemblies of 3D hydrogel materials with heterogeneous compositions and functions now will be discussed in detail with an emphasis on highlighting the advantageous features. These embodiments depict the novel and non-obvious features of fluidic infiltrative assemblies shown in the accompanying drawings, which are for illustrative purposes only. These drawings include the following figures:

FIGS. 1A-1B illustrate an infiltrative assembly process and corresponding images, respectively, in accordance with an embodiment of the invention.

FIG. 1C illustrates mold indentations and corresponding hydrogel protrusions showing hydrogel-to-mold fidelity in accordance with an embodiment of the invention.

FIGS. 1D-1E illustrate a hydrogel donut in accordance with an embodiment of the invention.

FIG. 1F illustrates a square-pyramid mold and resulting structural, synthetic hydrogel in accordance with an embodiment of the invention.

FIG. 1G illustrates a cubic mold and resulting thermosensitive hydrogel in accordance with an embodiment of the invention.

FIG. 1H illustrates a square-pyramid mold and resulting ionic hydrogel in accordance with an embodiment of the invention.

FIG. 2A are schematics diagrams illustrating infiltration methods in accordance with an embodiment of the invention.

FIG. 2B are diagrams corresponding to infiltration methods with varying inlet flow rates, infiltrated volumes, and diffusion time, respectively, in accordance with an embodiment of the invention.

FIGS. 2C-2D are schematics diagrams illustrating 3D hydrogels showcasing infiltration methods and corresponding hydrogels, respectively, in accordance with an embodiment of the invention.

FIGS. 2E-2F illustrate microfluidic-inspired mixer mold schematics and resulting hydrogels, respectively, from control and mixed structures in accordance with an embodiment of the invention.

FIGS. 2G-2H illustrate particle separator mold schematics and resulting hydrogels, respectively, exhibiting still microparticle-tipped needle array in accordance with an embodiment of the invention.

FIG. 3A is a graph illustrating tensile behavior characteristics of hydrogels in accordance with an embodiment of the invention.

FIG. 3B is a graph illustrating contraction characteristics of a thermosensitive hydrogel in accordance with an embodiment of the invention.

FIG. 3C is a graph illustrating transparency characteristics of a hydrogel in accordance with an embodiment of the invention.

FIG. 3D illustrates a bar-based fluidic mold with interchangeable inlets for creating various gradients in accordance with an embodiment of the invention.

FIGS. 3E-3H are graphs illustrating quantifications of hydrogel gradients (stiffness, material constituency, dopant concentration, and chemical moiety, respectively) at slow and fast gelation rates in accordance with an embodiment of the invention.

FIG. 4A illustrates a partially collapsing table mold and resulting control and gradient hydrogel in accordance with an embodiment of the invention.

FIG. 4B illustrates an octet-truss lattice mold and resulting interpenetrating network hydrogel in accordance with an embodiment of the invention.

FIG. 4C illustrates a thermal flower mold and resulting fluorescent bilayer hydrogel in accordance with an embodiment of the invention.

FIG. 4D illustrates an egg mold and resulting hydrogel with a core “yolk” of gold nanoparticles (GNPs) in accordance with an embodiment of the invention.

FIG. 5 is a flow chart illustrating a process for generating a 3D hydrogel (may also be referred to as an “infiltrative assembly process”) in accordance with an embodiment of the invention.

### DETAILED DESCRIPTION OF THE DRAWINGS

The following detailed description describes the present embodiments with reference to the drawings. In the drawings, reference numbers label elements of the present embodiments. These reference numbers are reproduced below in connection with the discussion of the corresponding drawing features.

Turning now to the drawings, fluidic infiltrative assemblies of 3D hydrogel with heterogeneous compositions and functions are further described below. 3D hydrogels may be powerful, multifunctional materials that may be utilized as building blocks in next-generation systems. Modern schemes to print complex 3D hydrogels are advancing rapidly; however, they possess several limitations including, but not limited to, polymer incompatibility or difficulty in imparting continuous heterogeneity in composition or function. As further described below, the present embodiments illustrate fluidic infiltrative assemblies and processes for synthesizing programmable hydrogel systems with tunable form and function in 3D. In many embodiments, such approaches may utilize stereolithographic printer/resin to fabricate high-resolution molds followed by programmed infiltration and gelation of hydrogel prepolymers. In various embodiments, the mold may be sacrificed to yield 3D, multifunctional hydrogels exhibiting user-defined heterogeneity. The present embodiments may be compatible with numerous in-situ gelling polymers and modifiers ranging from interpenetrating networks of organic or synthetic polymers to functional materials possessing dense concentrations of nanomaterials or fluorescent markers, to name a few. The present embodiments are accessible and versatile and may allow for the fabrication of complex, multimaterial constructs with tunable 3D environmental responses.

In many embodiments, the combination of sacrificial hydrogel templating with coordinated injection molding strategies may enable the facile synthesis of unique, soft multi-hydrogel architectures. This versatile approach may be accessible via various components including, but not limited to, commercially available printers and resins and may facilitate the development of more complex, multi-functional 3D hydrogel architectures with programmable response. In various embodiments, the present embodiments may be readily adaptable to a large variety of existing in-situ gelling hydrogel formulations with minimal modification, enabling a diverse set of protocols from various existing methods to be adapted using the present embodiments. Fluidic sculpting and release of 3D hydrogels in accordance with embodiments of the invention are discussed further below.

### Fluidic Sculpting and Release of 3D Hydrogels

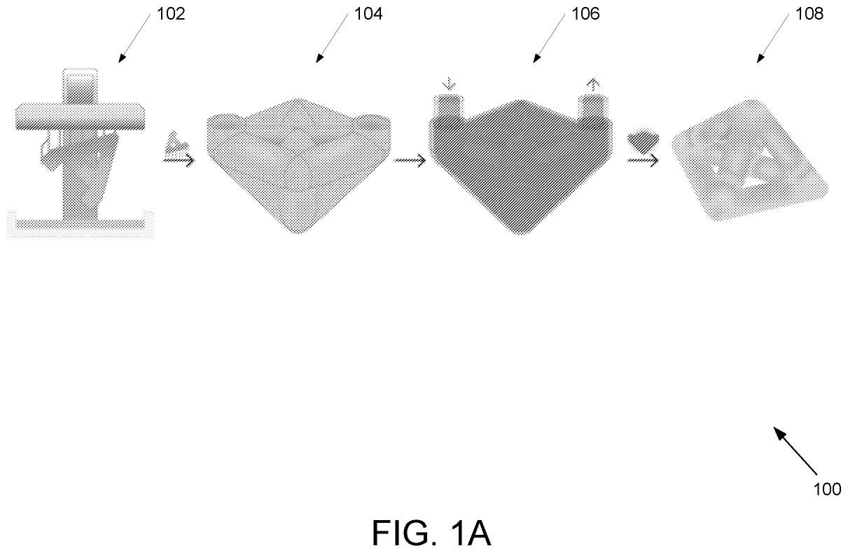

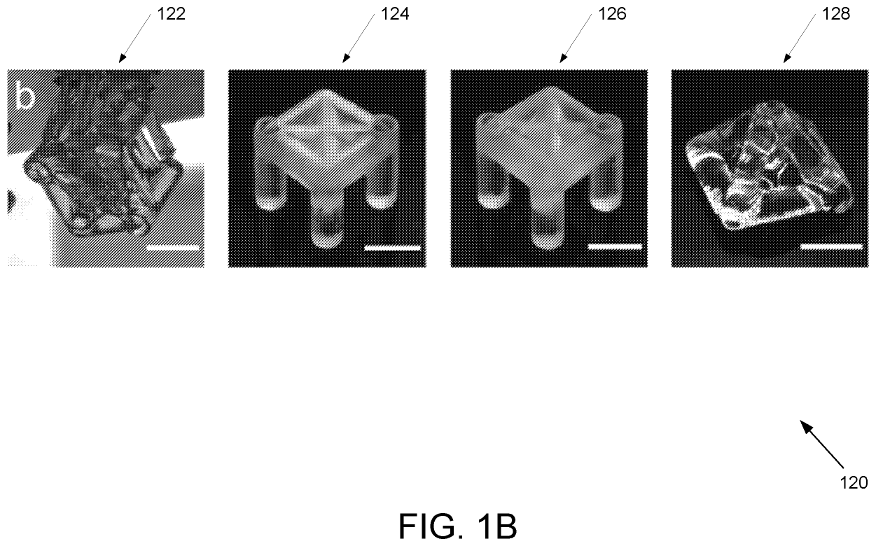

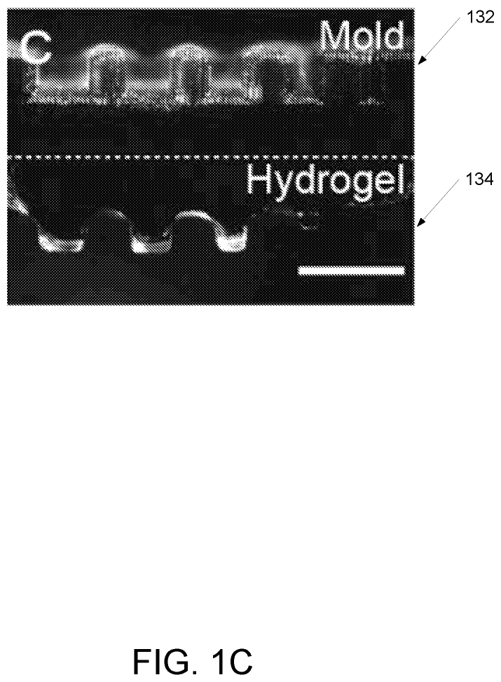

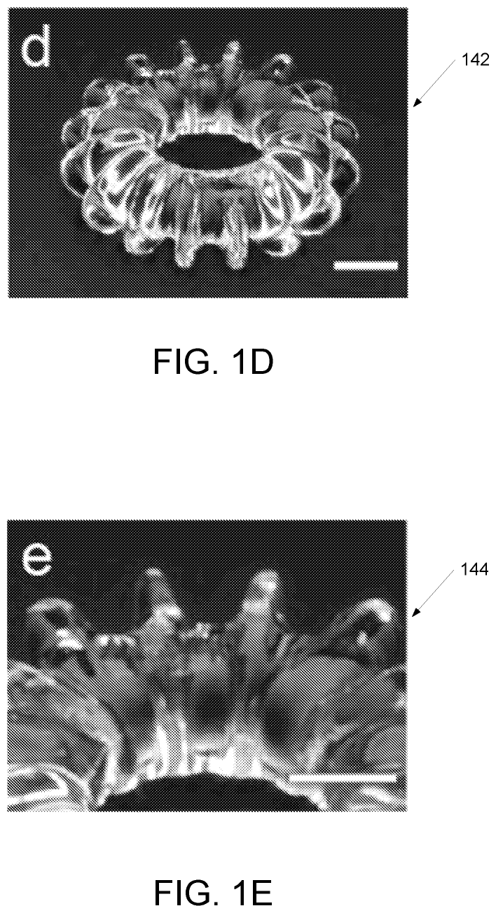

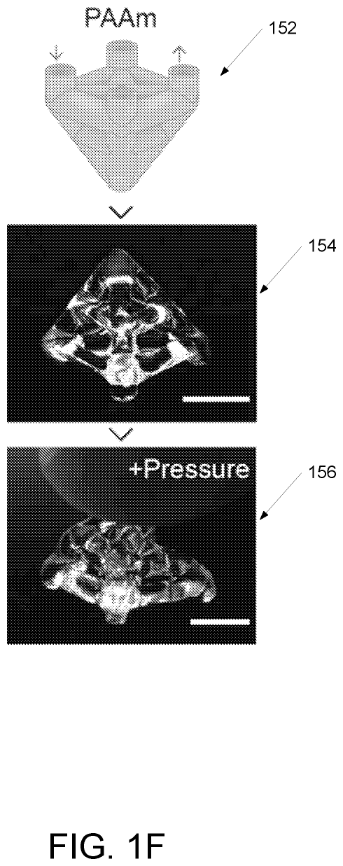

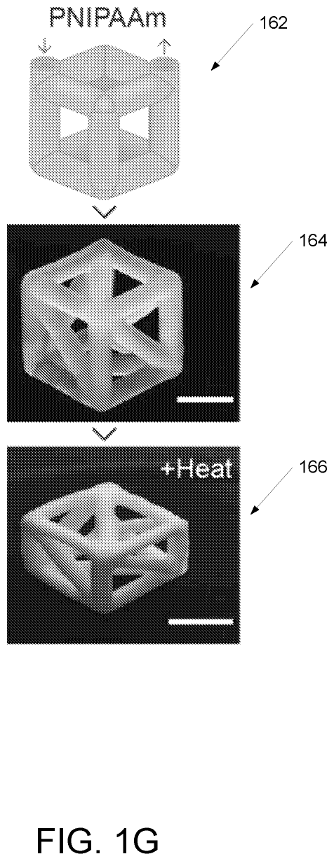

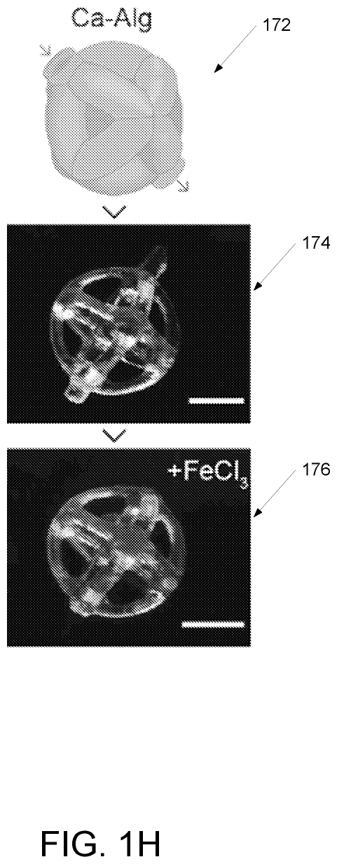

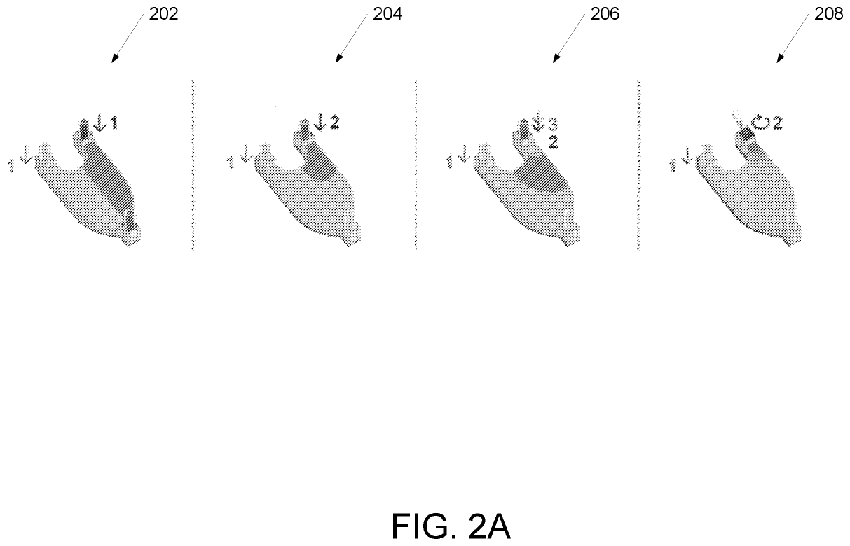

Fluidic infiltrative assemblies may be generated utilizing various processes including, but not limited to, an infiltrative assembly process as further described below. An infiltrative assembly process and corresponding images in accordance with an embodiment of the invention is shown in FIGS. 1A-1B. As illustrated, a sacrificial, fluidic mold may be 3D-printed and post-processed prior to fluidic infiltration with a select hydrogel precursor. The mold may be dissolved in a gel-dependent manner and the resulting gel may be left in deionized water (DI) to recover. In reference to FIG. 1A, the infiltrative assembly process 100 may include (1) 3D-printing (102) of a fluidic mold and post-processing (104); (2) fluidic mold infiltration (106), such as, but not limited to, infiltration (106) with a hydrogel precursor solution and in-situ gelation; and (3) release (108) of the hydrogel by dissolution of the encompassing mold. In various embodiments, steps (1) and (3) may be primarily responsible for determining the efficacy of the hydrogel sculpting process while step (2) may provide the ability to impart multifunctional attributes to their final construct through the modulation of precursor solutions infiltrated into inlets defined in the mold, as further described below. In some embodiments, the post-processing (104) may include an IPA bath, UV post-cure, and support removal. Images 120 corresponding to the process 100 in accordance with an embodiment of the invention is shown in FIG. 1B. The images 120 may include an initial fluidic mold 122, a post-processed fluidic mold 124, an infiltrated fluidic mold 124, and a released hydrogel 126.

In reference to FIG. 1A, in step (1), the effective print resolution of the 3D printer and the fidelity of the hydrogel material to its printed shape may determine the resolution of the resultant material. For example, SLA printers may readily print complex geometries down to nano-scale resolution. Although any one of a variety of printers may be utilized, the present embodiments will be discussed in the context of SLA printers. In various embodiments, SLA printers may enable significantly finer structural features (and enable smooth or rounded walls) than those achievable in wax or sugar printing strategies. In the present embodiments, a commercially available 3D printer (e.g., Phrozen), alongside a commercially available resin (e.g., 3DM-ABS) may be utilized to print molds. Factors such as the properties of the printing resin, the printing parameters, and the orientation of the mold while printing may cause the dimensions of the mold (and subsequently the hydrogel) to differ from the intended design. Commercially available, low-cost SLA printers may print at a putative resolution of down below 50 μm, however in practice it may be difficult to generate structural features at these sizes. For a low-cost setup, a well-defined ridge-openings down to 200 μm may be printed; however, more weakly defined openings may be achieved down towards 150 μm. Mold indentations and corresponding hydrogel protrusions in accordance with an embodiment of the invention is shown in FIG. 1C. Mold indentations 132 and corresponding hydrogel protrusions 134 for linewidths between 100-500 μm are illustrated. The fidelity of the hydrogel precursor to the mold may also affect the final synthesized material as the precursor solution, depending on its surface tension, may trap air within the small, enclosed areas of a mold, rendering a particular feature absent or malformed on the hydrogel. As further described below, several techniques may be utilized to eliminate this issue, primarily involving pretreatment of the mold with low surface tension solutions (mixed with surfactant or solvent) prior to infiltration of the prepolymer.

A hydrogel donut in accordance with an embodiment of the invention are shown in FIGS. 1D-1E. A hydrogel donut 142 with 500 μm ridges in accordance with an embodiment of the invention is shown in FIG. 1D. A close-up of the ridges 144 in accordance with an embodiment of the invention is shown in FIG. 1E. In many embodiments, proper characterization of a 3D printer's effective resolution, the resin, and the properties of a hydrogel precursor solution should be considered to obtain a high-quality, 3D hydrogel.

In various embodiments, step (3) of process 100 may be utilized in determining whether the process is viable for a particular application as the cured SLA resin should be dissolvable and the hydrogel should survive the degradation. Various resins such as, but limited to, a commercial ABS (e.g., acrylonitrile butadiene styrene)-like resin may be utilized. Most SLA resins are typically robust against solvent attack, however the ABS-like resin could be more easily degraded in solvent (ABS printed from extrusion printers can be etched in acetone). Ethanol (EtOH), isopropanol (IPA), acetone (ACE), and 1,1,1,3,3,3-hexafluoro-2-propanol (HFIP), are described herein for illustrative purposes, as potential water-miscible solvents for the printed material. Results of the testing revealed that HFIP was the only solvent capable of dissolving the cured resin. HFIP may be used in lieu of water during the synthesis of some hydrogels and, due to its polarity and water miscibility, may be compatible with a variety of polymerized hydrogel. Subsequent testing of the survivability and behavior of polyacrylamide (PAAm), poly(n-isopropylacrylamide) (PNIPAAm), and calcium alginate (Ca-ALG) hydrogels was performed to determine an optimum degradation scheme for three types of hydrogels that represented natural and synthetic sources, different crosslinking mechanisms, and unique functionalities, as further described below.

Optimization of the degradation process on a hydrogel-specific basis may allow for the creation of small, 3D hydrogel structures that retain their unique functionality and reflect the resolution of the SLA printer. A square-pyramid mold 152 and resulting PAAm hydrogel 154 withstanding pressure 156 in accordance with an embodiment of the invention are shown in FIG. 1F. A cubic mold 162 and resulting PNIPAAm hydrogel 164 exhibiting thermosensitivity 166 in accordance with an embodiment of the invention are shown in FIG. 1G. A square-pyramid mold 172 and resulting colored Ca-ALG hydrogel 174 after secondary crosslinking with FeCl₃ 176 in accordance with an embodiment of the invention are shown in FIG. 1H. Degradation schemes were developed to minimize the time hydrogels spent in the solvent and the concentration of HFIP, while maximizing the rate of mold degradation as excessive time spent in high concentrations of HFIP led to the gel becoming more brittle and potentially broken as the resin shell deformed and degraded. In many embodiments, by increasing the temperature of the degradation reaction, the concentration of the HFIP and the solvent exposure time may be minimized while achieving a satisfactory mold degradation rate. For PAAm and Ca-ALG hydrogels 154, 174, the degradation process may be performed, for example, at a temperature of 70° C. in 50% HFIP (determined empirically to provide a good degradation rate without exceeding the boiling point of the HFIP mixture). Further, for PNIPAAm hydrogels 164, 100% HFIP at 50° C. may be utilized since an HFIP mixture could induce co-nonsolvancy effects that would deswell the gel structure. Due to the more volatile nature of PNIPAAm (which swells and deswells aggressively depending on environment), these gels may sometimes call for additional tweezer-assisted mold-bit removal after initial solvent treatment. The more brittle behavior of hydrogel in HFIP may be improved by introduction of glycerol to the precursor solution which acts both as a plasticizer and substitutes for water molecules that enhances hydrogel performance during its short-term exposure to solvent. Further, alternative SLA resins that degrade in milder conditions (such as alkaline water solutions) may be utilized to improve the versatility.

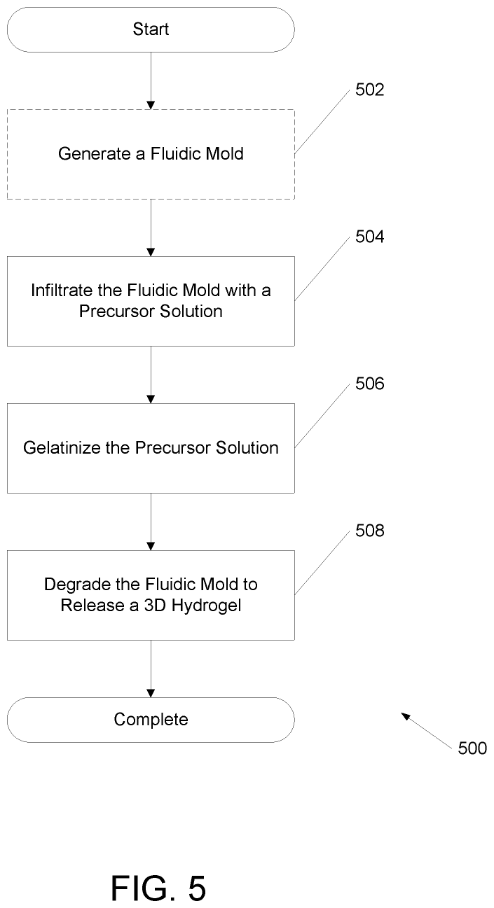

An infiltrative assembly process in accordance with an embodiment of the invention is shown in FIG. 5. The process 500 may include generating (502) a fluidic mold using various processes as described herein. In some embodiments, the fluidic mold may be generated (502) using a variety of 3D printing processes and/or techniques as described herein. However, the 3D printing processes and/or techniques are merely exemplary, and one of ordinary skill in the art would appreciate that various other processes may be utilized to generate a fluid mold. The process 500 may also include infiltrating (504) the fluidic mold with a precursor solution as described here. As described herein, the infiltrating (504) of the fluidic mold may include various techniques such as, but not limited to, co-flow, sequential flow, consecutive flow, diffusion, etc. In many embodiments, the 3D hydrogel may be programmed for various heterogeneous compositions and/or functions, as described herein. The process 500 may also include gelatinizing (506) the precursor solution to a 3D hydrogel, as described herein. In addition, the process 500 may also include degrading (508) the fluidic mold in a degradation solution to release the 3D hydrogel, as described herein.

Although specific processes for fluidic sculpting and release by 3D-printing fluidic molds, infiltration with hydrogel precursor solution, and release of hydrogel by dissolution of molds (may be collectively referred to as “infiltrative assembly process”) are discussed above with respect to FIGS. 1A-1H and 5, any of a variety of processes for fluidic sculpting and release utilizing various printing techniques, materials including, but limited to, resins and hydrogel precursor solutions, gelation techniques, and dissolution using a variety of solutions as appropriate to the requirements of a specific application can be utilized in accordance with embodiments of the invention. Infiltrative assemblies of hydrogels with gradient compositions in accordance with embodiments of the invention are discussed further below.

Infiltrative Assemblies of Hydrogels with Gradient Compositions

The infiltration step of the process may allow for the creation of heterogeneous hydrogel constructs. In many embodiments, this may occur through control of infiltrated precursor solutions alongside their gelation rate. In several embodiments, inlet flow rates, infiltrated volumes, and flow stabilization times may be programmed to modify the local characteristics of the final hydrogel. Additionally, controlling the magnitude of inlet flow rates and the bulk gelation rate of the hydrogel precursor solutions, for example, through crosslinker concentration, may enable control over the gradient interfaces that occur between different sections of the hydrogel. Slower flow rates may encourage near laminar flows that can yield more defined interfacial boundaries, whereas faster flow rates may encourage turbulent flows that can stimulate the formation of interfacial gradients. Inversely, slower bulk gelation rates may translate to longer time frames over which diffusion can occur between separate regions facilitating gradient formation, while faster gelation rates may reduce such time frames and encourage more defined boundaries between regions. Furthermore, control over the infiltrated volumes yields regions of varying size may add further complexity to the final gel structures.

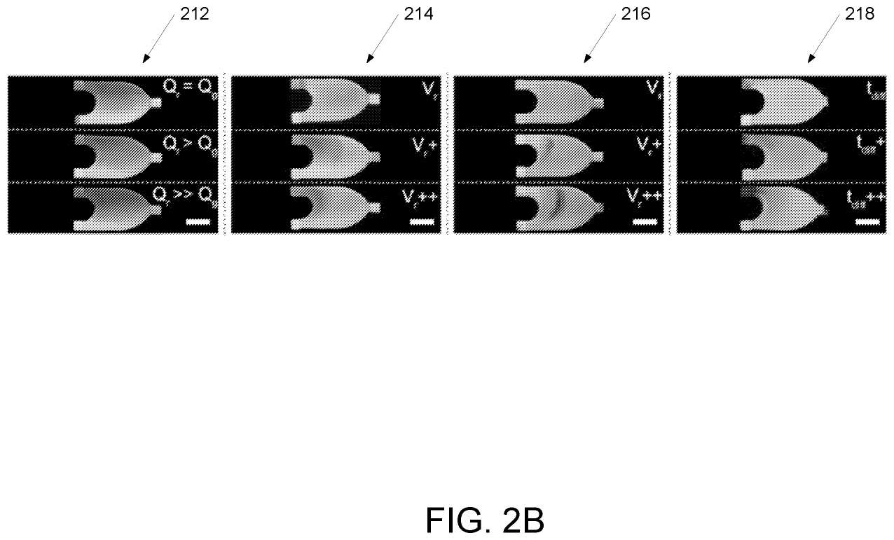

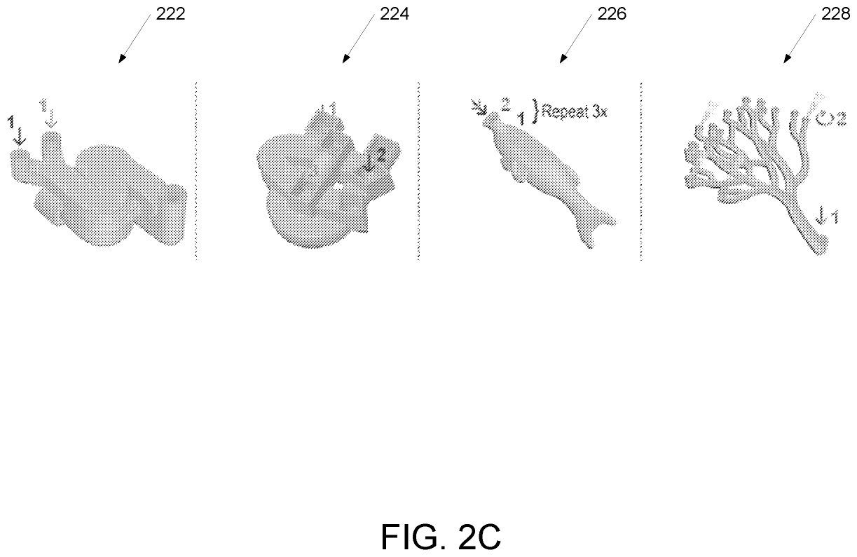

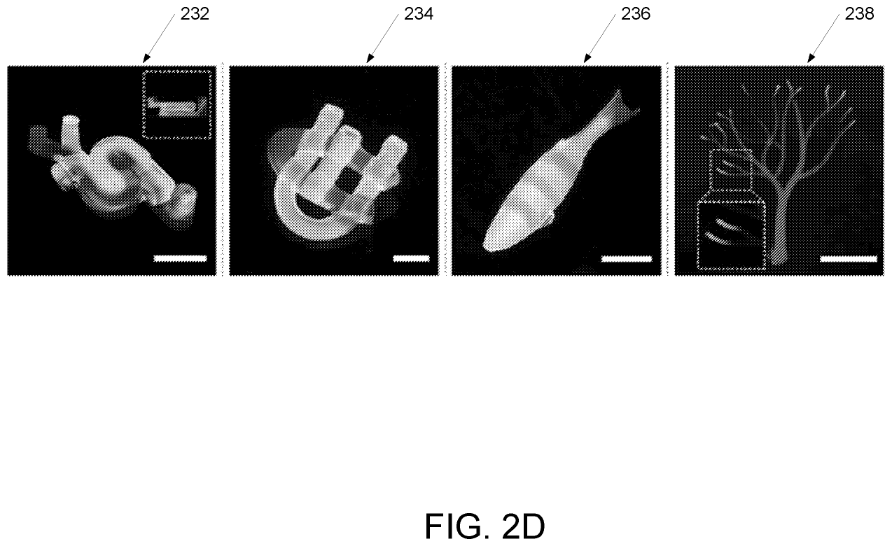

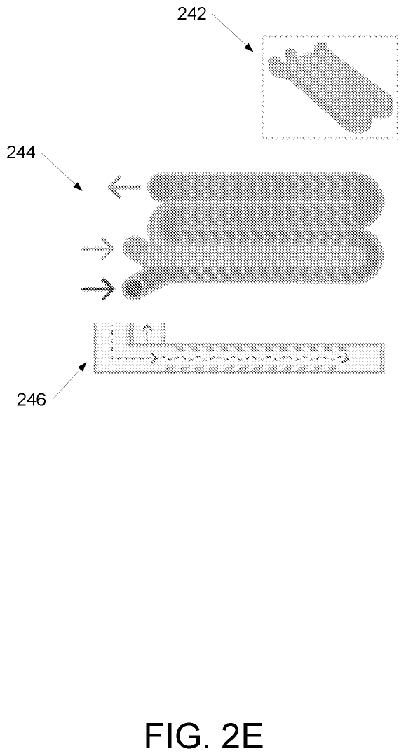

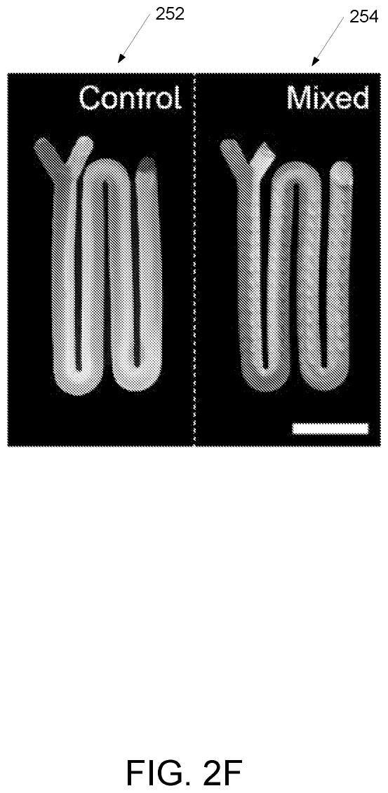

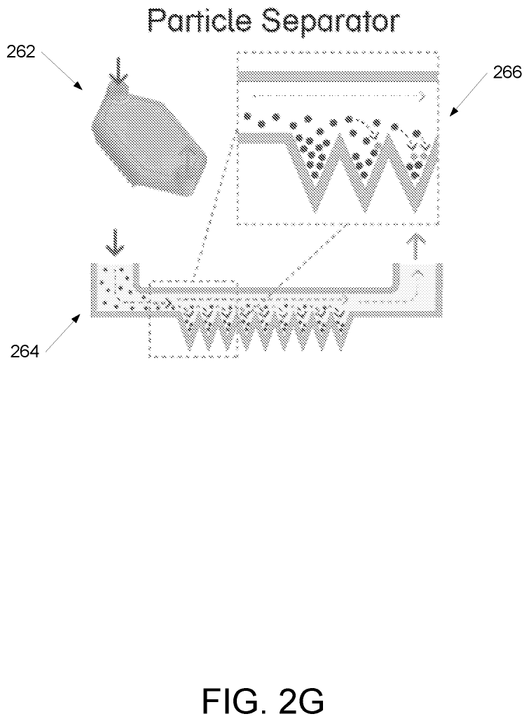

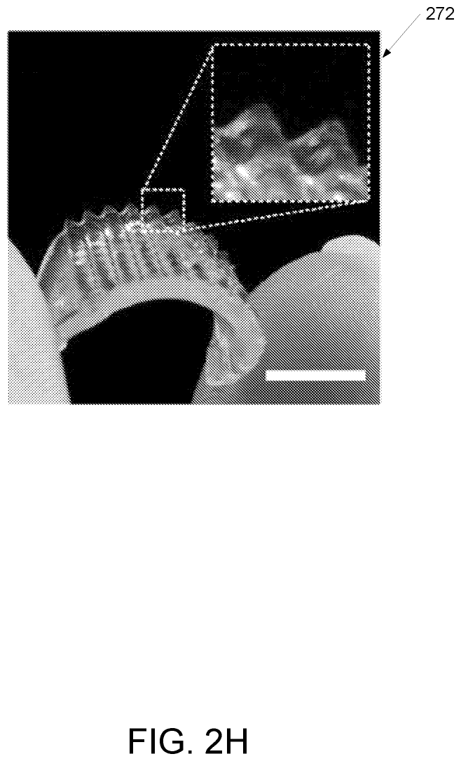

Simple 3D printed fluidic molds with two inlets and one outlet may be used to characterize how four basic methods of fluidic infiltration (co-flow, sequential flow, consecutive flow, and diffusion) can be modulated to yield structurally-complex 3D hydrogels. Schematics diagrams illustrating infiltration methods in accordance with an embodiment of the invention are shown in FIG. 2A. In many embodiments, methods of fluidic infiltration may include co-flow 202, sequential flow 204, consecutive flow 206, and/or diffusion 208. Utilizing such simplified scenarios, the infiltration may be characterized. For example, using two precursor solutions (one doped with fluorescein-modified and the other with rhodamine-modified monomer) results could be uniquely coordinated. Diagrams corresponding to infiltration methods with varying inlet flow rates, infiltrated volumes, and diffusion time, respectively (scale bar=3 mm) in accordance with an embodiment of the invention are shown in FIG. 2B. For example, diagram 212 corresponds to co-flow 202, diagram 214 corresponds to sequential flow 204, diagram 216 corresponds to consecutive flow 206, and diagram 218 corresponds to diffusion 208. When flowing two precursor solutions at the same time through a mold (co-flow), differences in inlet flow rates yielded hydrogel regions of different sizes within a single gel as illustrated in diagram 212. Sequential flow through alternate inlets could be used to modulate the shape and size of a secondary region within a main hydrogel as illustrated in diagram 214. Here the second infiltrated precursor may displace a portion of the initially infiltrated precursor, the volume of which may control the size of the new region. Consecutive flow operates in a manner like sequential flow, however, occurs through the same inlet. This may enable the creation of multiple, secondary hydrogel regions within a primary hydrogel as illustrated in diagram 216. The size and shape of these regions may be defined by the infiltrated volumes and inlet flow rates, respectively. Lastly, diffuse regions of another precursor solution can be incorporated into a gel via passive or active diffusion as illustrated in diagram 218. For such experiments, the equalization of precursor solution densities improved the reliability of the final synthesized material.

These infiltration and fluidic manipulation strategies may be readily applied to create 3D hydrogels with localized structural and functional characteristics. Schematics diagrams illustrating 3D hydrogels showcasing infiltration methods and corresponding hydrogels in accordance with an embodiment of the invention are shown in FIGS. 2C-2D, respectively. In FIG. 2C, the “3-layer serpentine” mold and infiltration method 222, the “UCI” mold and infiltration method 224, the “fish” mold and infiltration method 226, and the “capillary” mold and infiltration method 228, are illustrated. In many embodiments, the gels showcased may be dubbed 3-layer serpentine, UCI, fish, and capillary (scale bars=3 mm; 3 mm; 3 mm; 5 mm, respectively). In several embodiments, such structures may be configured with fluorescent PAAm-co-FOA and PAAm-co-RHO as the gel constituents. An alternating, three-layer serpentine structure highlights co-flow-mediated generation of a hydrogel with dual regions of fluorescent polymer that traverse the entire length of the mold as shown in diagrams 222 and 232 of FIGS. 2C and 2D, respectively. PAAm-co-FOA precursor solution and PAAm-co-RHO precursor were infiltrated at equal flow rates (0.3 mL/min) to maintain approximately the same space within the molds. The resultant gel maintained separate regions of PAAm-co-FOA and PAAm-co-RHO with slight diffusion throughout the winding 3D interface within the material. To highlight sequential flow generation, a multilayer UCI mold was utilized where the U and the I were made out of PAAm-co-FOA and the C was made out of PAAm-co-RHO as illustrated in diagrams 224 and 234 of FIGS. 2C and 2D, respectively. In several embodiments, to make this gel, the U may first be filled in with PAAm-co-FOA precursor, then the C may be filled in with PAAm-co-RHO precursor before the U fully gelled, and, lastly, the I may be filled with PAAm-co-FOA precursor before the C fully gelled. Slight diffusion between the U, C, and I sections of the mold clearly indicate that the resulting structure is a single gel rather than three gelled on top of each other.

To illustrate consecutive flow generation, a fish mold with a single inlet/outlet may be 3D printed with the intent of creating a striped hydrogel fish as illustrated in diagrams 226 and 236 of FIGS. 2C and 2D, respectively. Using a micropipette, alternating aliquots of PAAm-co-FOA and PAAm-co-RHO precursor solutions may be gently infiltrated into the mold until the mold is filled. The thickness of the layers may be visually approximated, leveraging the distinct colors of the precursor solutions and the transparency of the mold. Lastly, to show how diffusion could be used to add complexity to a 3D hydrogel, a capillary-like mold with a large inlet and several 3D interleaving, vessel-like branched outlets was constructed as illustrated in diagrams 228 and 238 of FIGS. 2C and 2D, respectively. In many embodiments, the mold may first be fully infiltrated with a PAAm precursor solution before small aliquots of PAAm-co-FOA are added to each outlet and allowed to diffuse into the vessel tips. The aliquot volumes added to the outlets may be dependent on their height from their support—this is because vessels above others in height experienced gravity-mediated diffusion that may reduce the amount of PAAm-co-FOA needed to achieve the same diffusion as lower vessels.

Microfluidic operators may also be built-in to the sacrificial 3D-printed shell to further facilitate control over the resultant hydrogel. Microfluidic-inspired mixer mold schematics and resulting hydrogels from control and mixed structures (scale bar=5 mm) in accordance with an embodiment of the invention are shown in FIGS. 2E-2F, respectively. As a demonstration of this, two molds inspired by microfluidic operations, a mixer and a gravity separator, were developed. As illustrated in FIG. 2E, the mixer mold 242 was inspired by a staggered herringbone mixer and has dual herringbone shaped protrusions on the top and bottom of the molds inner surface down the length of the mold to facilitate mixing between PAAm-co-FOA and PAAm-co-RHO. A top view schematic 244 and a side view schematic 246 are provided in FIG. 2E. Control and mixer-integrated molds may be co-infiltrated with fluorescing precursor solutions and allowed to gel. As illustrated in FIG. 2F, control molds 252 may yield materials with highly distinct fluorescent regions, whereas mixer-integrated molds 254 may generate more intermixed constructs, particularly at the middle and end of the channel.

Particle separator mold schematics and resulting hydrogels, respectively, exhibiting still microparticle-tipped needle array (scale bar=3 mm) in accordance with an embodiment of the invention are shown in FIGS. 2G-2H. The separator mold 262 was inspired by microfluidic gravity separators and synthesizes a 3D needle-like array with square pyramidal indentations on the bottom as shown in the side schematic 264 of FIG. 2G. This structure allowed for the sedimentation of stiff blue polystyrene microspheres from a PAAm precursor solution as illustrated in the close-up view 266 of FIG. 2G. When the mold was removed, the bulk of the resulting gel remained clear, but the tips (as shown in close-up view 272) of the square pyramid array were bright blue, demonstrating that the mold was successful in separating the microspheres from the precursor solution to form a hydrogel with stiff needle-like tips as illustrated in FIG. 2H.

Although specific infiltrative assemblies of hydrogels with gradient compositions are discussed above with respect to FIGS. 2A-2H, any of a variety of infiltrative assemblies of hydrogels with gradient compositions as appropriate to the requirements of a specific application can be utilized in accordance with embodiments of the invention. Hydrogels with programmable heterogeneity in functions in accordance with embodiments of the invention are discussed further below.

Hydrogels with Programmable Heterogeneity in Functions

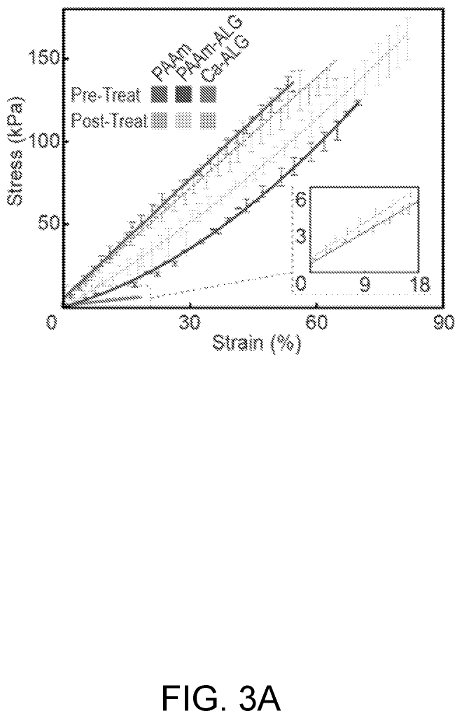

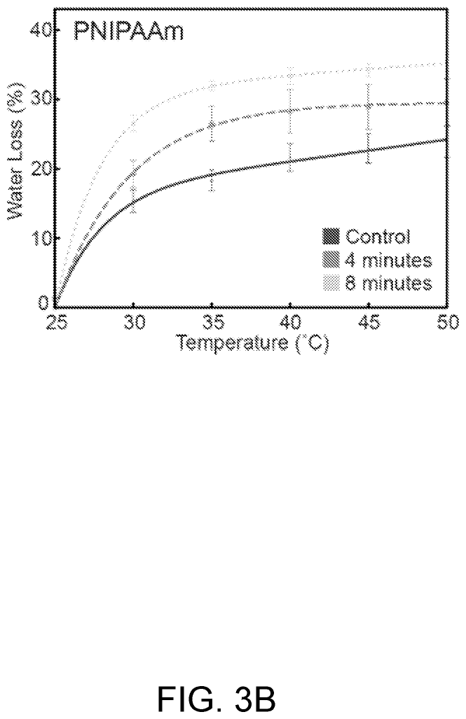

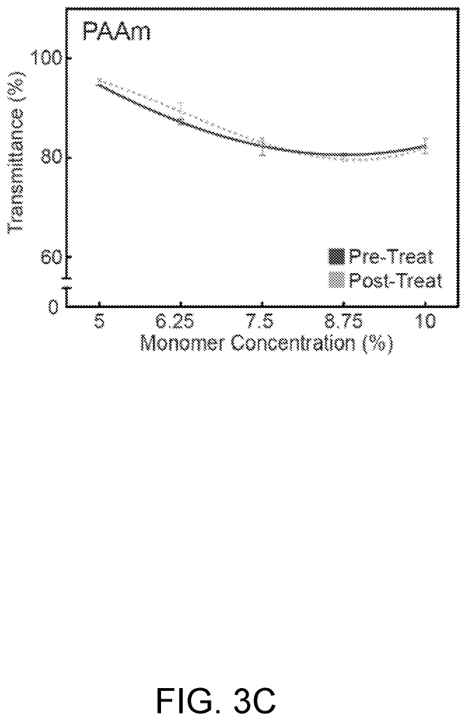

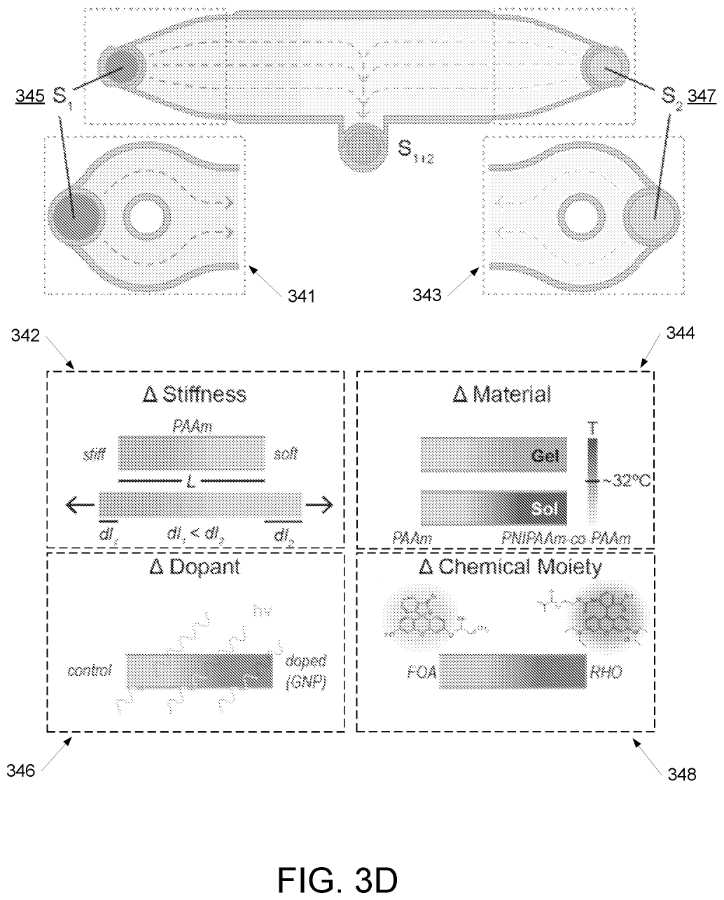

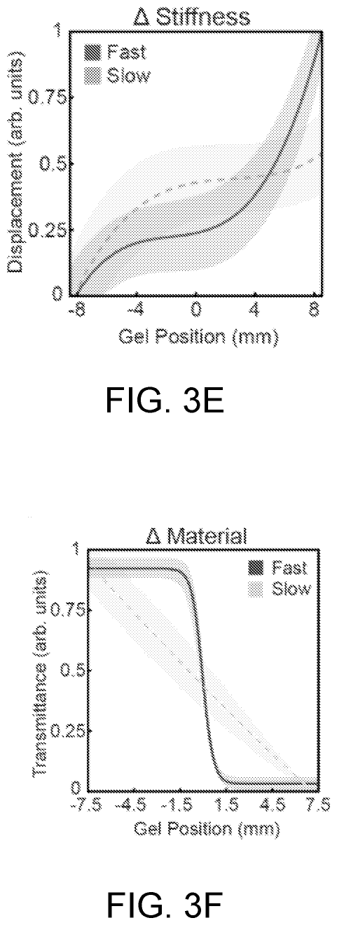

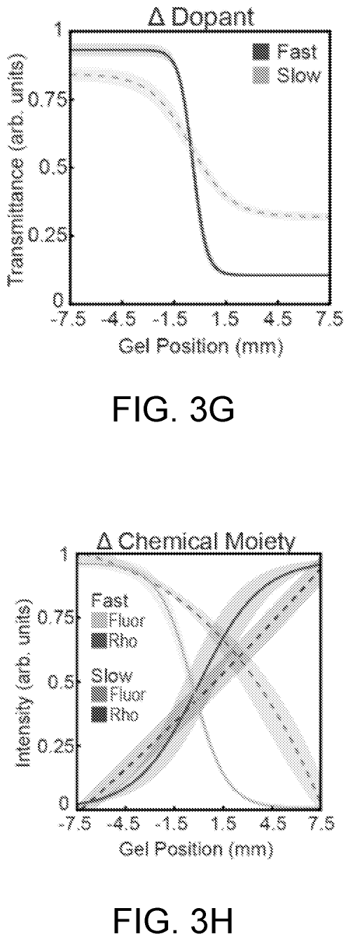

Hydrogel structural and functional properties following HFIP treatment may be investigated to assess the impact of the sacrificial release step on hydrogel performance. In many embodiments, the effect of HFIP on the mechanical behavior may be first assessed. In some embodiments, tensile tests may be performed on Type IV “dog bone” hydrogel specimens of PAAm, Ca-ALG, and an interpenetrating polymer network (IPN) of PAAm, and Ca-ALG (PAAm-ALG) subjected to the conditions of the mold removal step in accordance with ASTM Standard D638-14. A graph illustrating tensile behavior characteristics of a hydrogel in accordance with an embodiment of the invention is shown in FIG. 3A. A Stress vs. Strain graph is illustrated showing the difference in tensile behavior of a hydrogel before and after exposure to the hydrogel-specific dissolution protocols (n=4). No significant differences in the stress/strain behavior of the hydrogels were found as they exhibited nearly the same behavior before and after solvent exposure as illustrated in FIG. 3A. Thermosensitive PNIPAAm hydrogels may also be subjected to these conditions to evaluate whether HFIP impacted the “smart,” swelling behavior of the gels to temperature. A graph illustrating contraction characteristics of a hydrogel in accordance with an embodiment of the invention is shown in FIG. 3B. PNIPAAm contraction in response to higher temperatures after subjecting to set HFIP exposure times was observed. Greater water loss percentage due to temperature was associated with increasing solvent exposure (n=3). Longer exposure to the solvent increased PNIPAAm sensitivity to thermal stimuli, as they exhibited greater water loss percentages to temperature in proportion with the time spent in solvent as illustrated in FIG. 3B. The mechanism behind this phenomenon may be because the HFIP treatment primes the material for subsequent structural transformations (the solvent itself deswells the hydrogel). A graph illustrating transparency characteristics of a hydrogel in accordance with an embodiment of the invention is shown in FIG. 3C. Transparency of PAAm hydrogels before and after exposure to its dissolution protocol (n=3) were observed. PAAm, Ca-ALG, and PNIPAAm hydrogels were tested for changes in their opacity that could potentially be introduced under mold removal conditions. The opacity of the hydrogels remained unchanged following solvent exposure as illustrated in FIG. 3C.

In many embodiments, a primary advantage of the processes described herein include the ability to induce flow-defined heterogeneity within a 3D structure through a combination of geometric design, tuned infiltration, and control over material constituents. To highlight this, bar-like molds with two inlets at opposite ends and a centrally located outlet may be 3D printed to create gels with gradients in stiffness, monomer constituency, dopant concentration, and chemical moiety. A bar-based fluidic mold with interchangeable inlets for creating various gradients in stiffness, material constituency, dopant concentration, and chemical moiety in accordance with an embodiment of the invention is shown in FIG. 3D. In particular, gradients for stiffness is shown in diagram 342, material constituency in diagram 344, dopant concentration in diagram 346, and chemical moiety in diagram 348. While the latter three gradients utilized a simple bar-like mold for their structures, the stiffness gradient mold was modified to include dumbbell-like inlets 341, 343 and an array of hemispherical indentations (e.g., S₁ 345 and S₂ 347) spaced evenly across the length of the mold for displacement quantification. It was further tested whether these gradient materials could be modulated by simple control of gelation rate.

For the stiffness gradient, the dumbbell-like inlets 341, 343 on the modified mold became hydrogel grips for a 3D sculpted stretching fixture. This was infiltrated with 5% and 10% PAAm precursor solutions. Hemispherical protrusions 345, 347 were built-in along the length of the mold to enable quantification of local structural displacement under strain. Such integrated design may be a powerful advantage of this technique, which allows materials to be synthesized on a whim to fit experimental needs. These hydrogels were set on the fixture and imaged in stretched and unstretched states, where the stretching distance remained constant. All resulting hydrogels exhibited low displacement near the stiffer end of the gel (10% PAAm) and high displacement near the softer end of the gel (5% PAAm) with a point of inflection occurring at the center of the gels (gel position 0 mm). Graphs illustrating quantifications of hydrogel gradients (stiffness and material constituency) at slow and fast gelation rates in accordance with an embodiment of the invention as shown in FIGS. 3E-3F, respectively. Error bars and shaded regions represent standard deviation. The resultant stiffness gradient varied with the gelation rate as illustrated in FIG. 3E. Hydrogels with a faster gelation rate (Fast) exhibited a large differential in displacements (and highly varying stiffness) between the two sides of the gel. “Slow” gels with a reduced gelation rate exhibited a much smaller differential in displacement and more even stiffness across the structure. In several embodiments, the slower gelation rate allowed more time for diffusion of monomer from high to low concentration regions—thus leading to a more uniform material.

In several embodiments, material gradient gels were composed of co-infiltrated solutions of PAAm and PNIPAAm-co-PAAm, respectively. Resultant structures may be placed in a water bath above the lower critical solution temperature (LCST) of PNIPAAm to induce a sol-gel transition in PNIPAAm-co-PAAm within the hydrogel. This may be accompanied by a change in the opacity of the hydrogel. PAAm hydrogel may not be inherently thermosensitive, and local regions may turn opaque in correlation with the local PNIPAM concentration. Gradients of PNIPAAm-co-PAAm were quantified through measurement of the transmittance of light across the gel. All resulting hydrogels exhibited decreasing light transmittance closer to the PNIPAAm-co-PAAm side of the gel as illustrated in FIG. 3F. Hydrogels with a faster gelation rate (Fast) followed sigmoidal behavior with high light transmittance closer to the PAAm side of the gel, a narrow, gradated region between the two materials, and a consistently low light transmittance closer to the PNIPAAm-co-PAAm side. Gels with a slower gelation rate (Slow) also exhibited the same decline in transmittance from the PAAm side to the PNIPAAm-co-PAAm side but, rather than following sigmoidal behavior, the decline was more linear as the material gradient spanned the length of the gel due to more diffusion of NIPAM monomer.

A graph illustrating quantification of hydrogel gradient (dopant concentration) at slow and fast gelation rates in accordance with an embodiment of the invention is shown in FIG. 3G. Nanomaterial-dopant gradient gels may be composed of undoped and GNP-doped precursor solutions. Resultant gels may be imaged to quantify nanoparticle-induced red-purple coloration within the hydrogel. Hydrogels may have whiter/clearer coloration closer to the undoped side of the gel, while the purple GNP in the doped side of the gel absorbed/scattered light as illustrated in FIG. 3G. Hydrogels with a faster gelation rate (Fast) exhibited sigmoidal behavior with clear coloration on the undoped side, a narrow, graduated region between, and darker coloration on the doped side. Gels with a slower gelation rate (Slow) also exhibited sigmoidal behavior, however the maximum and minimum coloration on the undoped and doped sides respectively dropped as greater diffusion of the GNPs resulted in a more gradual gradient across the gel.

In addition, hydrogels with gradients of chemical moieties may be tested; in this case, two solutions modified with fluorescein and rhodamine, respectively, were utilized. A graph illustrating quantification of hydrogel gradient (chemical moiety) at slow and fast gelation rates in accordance with an embodiment of the invention is shown in FIG. 3H. Fluorescent images of the chemical-moiety gradient hydrogels were taken and quantified based on the fluorescent intensity across the length of the gels. Similar with previous graded gels, a faster gelation rate (Fast) may exhibit sigmoidal behavior with a smaller window between the top and bottom plateaus that may result from reduced diffusion time for the fluorophores. A slower gelation rate may result in greater diffusion of the fluorophores to the opposing sides and a somewhat more linear change in fluorescent intensity of the hydrogel across its length.

Although specific hydrogels with programmable heterogeneity in functions and quantifications of hydrogel gradients are discussed above with respect to FIGS. 3A-3H, any of a variety of hydrogels with programmable heterogeneity in functions and quantifications of hydrogel gradients as appropriate to the requirements of a specific application can be utilized in accordance with embodiments of the invention. Synthesis of 3D hydrogel systems in accordance with embodiments of the invention are discussed further below.

### Synthesis of 3D Hydrogel Systems

Through proper material selection and creative infiltration, unique multi-material structures with region-specific functionality may be constructed. As demonstration, four 3D structures were synthesized illustrating structural tunability, synergy between material choice and geometric constraint, and multimaterial functionality that may be achieved via present embodiments.

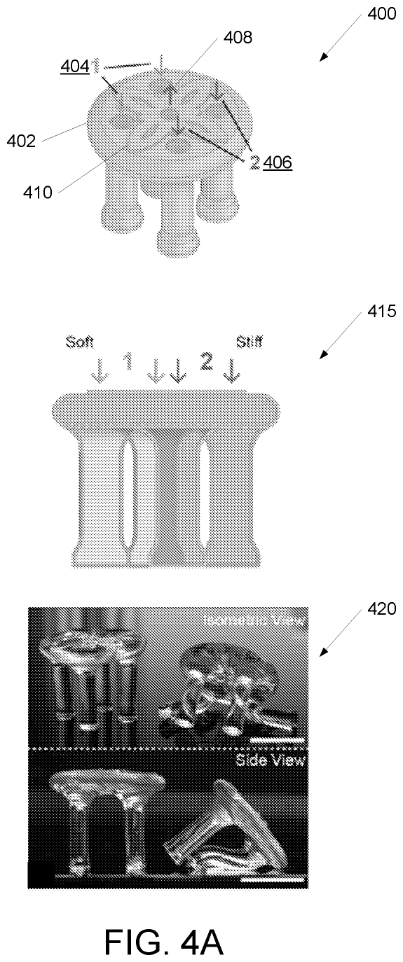

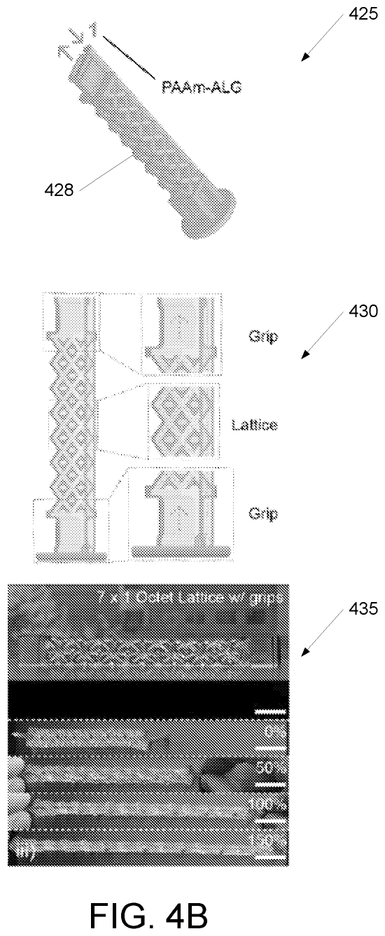

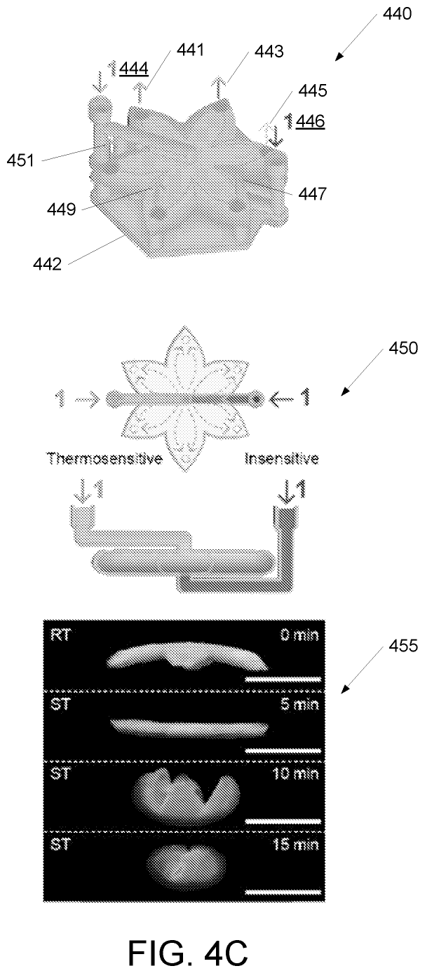

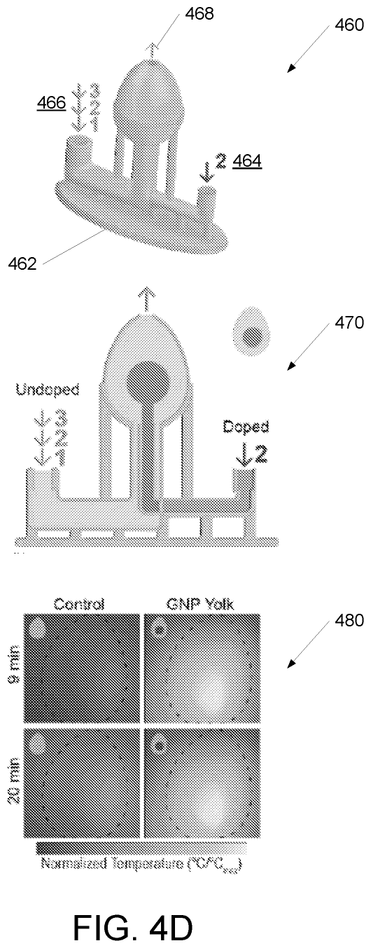

A partially collapsing table mold and resulting control and gradient hydrogel with two soft table legs (scale bar=5 mm) in accordance with an embodiment of the invention are shown in FIG. 4A. In many embodiments, this demonstrates facile control over the material properties of a free-standing hydrogel. In various embodiments, the ornate, gradient stiffness table 402 may include a first pair of inlets 404 and a second pair of inlets 406 above the legs, a central outlet 408, and a sub-millimeter flower flourish 410 configured above the table 402 to highlight structural tunability as illustrated in diagram 400 of FIG. 4A. The table 402 may be designed with ease of infiltration in mind, as the location of the inlets 404, 406 above the legs allowed for modulation of the material composition of each leg independently. In this case, 3.5% PAAm precursor solution (soft material) was infiltrated into two of the table legs using a micropipette, before the other legs were filled with 10% PAAm (stiff material) as illustrated in diagram 415 of FIG. 4A. Before any leg had completely gelled, the tabletop may be gently filled with more 10% PAAm precursor to connect the four legs together. The resulting gel may be a table with two legs that buckled under its own weight and cause the table to partially collapse towards its soft legs as illustrated in diagram 420 of FIG. 4A. This simple-to-make construct highlights how fluidic infiltration and material selection enables straightforward and rapid region-specific tuning of a complex, 3D hydrogel.

An octet-truss lattice mold and resulting interpenetrating network hydrogel (scale bar=1 cm) in accordance with an embodiment of the invention are shown in FIG. 4B. In several embodiments, an octet-truss lattice mold 428 may comprise seven repeating units in series and tensile grips on each end demonstrating the synergy that may be achieved between material choice and the structural control offered by the present embodiments as illustrated in diagram 425 of FIG. 4B. The octet-truss lattice may be the most common form of stretching-dominated, mechanical metastructure used for engineering applications as it functions as a light-weight energy absorption structure with ideal linear scaling of mechanical properties. In various embodiments, the mold may be designed with a long inlet that spans the length of the lattice to allow for infiltration from the bottom of the mold to eliminate bubbles, as bubbles translated to structural defects in the gel as illustrated in diagram 430 of FIG. 4B. In this example, infiltration was achieved with PAAm-ALG as this hydrogel exhibits excellent biocompatibility and unique mechanical properties. Such IPN gels may be difficult to synthesize using traditional 3D-printing techniques and may capitalize on the structural advantage of the octet-truss lattice. In many embodiments, a basic PAAm-ALG formulation may be sculpted into a high fidelity, octet-truss lattice with the ability to stretch to 2 times its original length if taken to failure as illustrated in diagram 435 of FIG. 4B.

A thermal flower mold and resulting fluorescent bilayer hydrogel with a gradient in temperature-responsive function (scale bar=5 mm) in accordance with an embodiment of the invention are shown in FIG. 4C. In several embodiments, a flower-like mold 442 may be fabricated to highlight environmental-responsiveness of 3D multimaterial constructs. This mold 442 may comprise two inlets 444, 446 entering above and below the central point (flowing red, fluorescent PAAm and green, fluorescent PNIPAM-co-PAAm respectively), and six petals with outlets 441, 443, 445, 447, 449, 451, on their tips. This forms a fluorescing, thermo-responsive hydrogel bilayer with a graduated interfacial boundary, as illustrated in diagram 440 FIG. 4C, that may be synthesized in-situ. Note that such fluorescent structures may be difficult to synthesize using direct laser printing due to bleaching in UV light. Thermo-responsive hydrogel bilayers incorporating PNIPAAm as its thermosensitive element may be generated by either forming one layer on top of another after complete gelation of the former or by adhering two layers together using an adhesive. These bilayers may often be employed as actuators in solutions that bend as the temperature exceeds the LCST of PNIPAAm. The PNIPAAm-co-PAAm-co-RHO precursor had a lower density than the PAAm-co-FOA precursor so the mold may be designed such that the less dense precursor may enter from above and the denser precursor may enter from below as illustrated in diagram 450 of FIG. 4C. The resulting gel may include a green and red hydrogel bilayer that closes like a flower when exposed to temperatures exceeding the top layers LCST, and additionally possess a graduated interfacial boundary linking the two materials together as illustrated in diagram 455 of FIG. 4C. By modifying the inlet flow rates of the precursors, the thickness of the layers may be changed and the contractile behavior of the resulting gel may be modulated to various specifications. Gels with greater complexity and functionality may be readily fabricated by modifying the mold geometry, the precursors, or the infiltration strategy.

An egg mold and resulting hydrogel with a core “yolk” of gold nanoparticles in accordance with an embodiment of the invention are shown in FIG. 4D. In various embodiments, the egg may be synthesized using sheath flow. In many embodiments, sheath flow may enable the rapid and facile synthesis of 3D encapsulated functionality through engineering flow and function within user-defined molds. High surface temperature of the egg upon green laser illumination indicates that the high interior temperature emanating from the center GNP of the egg. In several embodiments, an egg mold 462 may include opposing inlets 464, 466, small and large, may be utilized to meet below the egg portion of the mold where the small inlet 464 may enter the large inlet 466 and form a 3D sheath co-flow structure as illustrated in diagram 460 of FIG. 4D. This infiltration strategy allows for precursor of the small inlet 464 to be surrounded by the precursor entering from the large inlet 466 as the solutions fill the egg mold and exit through an outlet 468 at the top. By controlling the inlet flow rates and the inflow times, the resulting egg may have a hydrogel encapsulated within another hydrogel, a “yolk”, with a diffuse gradient between them as illustrated in diagram 470 of FIG. 4D. Initially, PAAm precursor may be infiltrated into the mold without the GNP-doped PAAm precursor to form the top portion of the egg. Once a bottom third of the egg mold had been filled, infiltrating a known volume of GNP-doped PAAm precursor without stopping the flow of the PAAm precursor may be utilized. After the volume has been fully infiltrated, the process may wait a few seconds to cut off the GNP-doped PAAm precursor from the inlet with PAAm precursor before stopping the infiltration. The resulting hydrogel may be a high-fidelity egg with a GNP “yolk” that induced a local temperature gradient when subjected to a laser stimulus as illustrated in diagram 480 of FIG. 4D. When exposed to a 125 mW, 532 nm, hand-held laser (e.g., Big Lasers) for 20 minutes, the egg may experience significant temperature increase in the GNP “yolk,” which resulting in heating at the surface of the hydrogel of that can be quantified via infrared thermography. In various embodiments, the core of the hydrogel may be significantly hotter than the surface.

Although specific processes for synthesis of 3D hydrogels systems are discussed above with respect to FIGS. 4A-4D, any of a variety of processes for synthesis of 3D hydrogel systems as appropriate to the requirements of a specific application can be utilized in accordance with embodiments of the invention. Methods and design considerations in accordance with embodiments of the invention are discussed further below.

### Methods and Design Considerations

Potential Materials—Acrylamide (AAm), n-isopropylacrylamide (NIPAAm), methylene bisacrylamide (MBAAm), ammonium persulfate (APS), N,N,N′,N′-tetramethylethylenediamine (TEMED), calcium carbonate (CaCO3), D-(+)-gluconic acid 8-lactone (GDL), fluorescein o-acrylate (FOA), trisodium citrate dihydrate, gold (III) chloride trihydrate (HAuCl4), sodium chloride (NaCl), dimethyl sulfoxide (DMSO), and iron (III) chloride hexahydrate (FeCl3). Isopropanol (IPA) and acetone (ACE). Sodium alginate (Na-ALG, viscosity 80-120 cp), 1,1,1,3,3,3-hexafluoro-2-propanol (HFIP), rhodamine methacrylate (RHO), and 3DM-ABS resin. In many embodiments, chemicals may be used without further purification. In various embodiments, aqueous solutions may be prepared using deionized water (DI) unless otherwise stated.

Three-Dimensional (3D) Printing and Post-Processing—3D Computer Aided Design (CAD) models of a fluidic mold may be made using various CAD products such as, but not limited to, SolidWorks® (Dassault Systèmes) and outputted as a standard tessellation file (STL). Support structures may be added manually in Meshmixer (Autodesk) to avoid auto-generating supports within the mold itself. The modified STL may be oriented and duplicated in Autodesk Netfabb (Autodesk) with the build volume of the program matching the build volume of the 3D printer. The file may be uploaded, sliced, and printed in a liquid crystal display stereolithography (LCD-SLA) 3D printer (e.g., Phrozen) with an XY-resolution such as, but not limited to, of 47 μm and a user-defined Z-resolution.

After printing, the molds may be removed from the build platform and placed in an IPA bath for 15 minutes. Resin remaining in the molds may be removed by vigorous shaking in paper towels or forcing the resin out with an air gun. Molds with resin cured in the internal area may be discarded. The molds may be placed in a UV-curing box (e.g., from Spierce Technologies) for 15 minutes, after which they may be ready for use.

Preparation of Hydrogel Stock Solutions—Stock solutions of the hydrogel monomers may be made in DI and stored at 4° ° C. until needed. PAAm precursor: 20% (w/w) AAm (10.16 g), 6% (w/w) MBAAm relative to AAm (0.6 g), 40 mL DI. PNIPAAm precursor: 20% (w/v) NIPAAm (8 g), 0.7% (w/v) MBAAm (0.28 g), 40 mL DI. ALG precursor: X % (w/v) Na-ALG, 40 mL DI. X refers to a value between 0.5 and 1.5 as these percentages may be used. PAAm-ALG precursor: 15% (w/w) AAm (4.514 g), 1.875% (w/w) Na-ALG (0.564 g), 0.35% (w/w) MBAAm relative to AAm (0.0158 g), 25 mL DI. Solutions containing Na-ALG were sonicated until the powders were completely dissolved.

Hydrogel Synthesis—PAAm Hydrogels: 10% (w/w) PAAm hydrogel: 500 μL PAAm stock, 470 μL DI, and 5 μL TEMED may be added to a microcentrifuge tube and mixed. 25 μL 10% APS may be added and quickly mixed into the solution via tube inversion. 10% (w/w) PAAm-co-FOA hydrogel: 500 μL PAAm stock, 465 μL DI, 5 μL TEMED, and 5 μL of a 100 mg/mL FOA solution in DMSO may be added to a microcentrifuge tube and mixed. 25 μL 10% APS may be added and quickly mixed into the solution via tube inversion. 10% (w/w) PAAm-co-RHO hydrogel: 500 μL PAAm stock, 445 μL DI, 5 μL TEMED, 5 μL DMSO, and 20 μL of a 100 mg/mL RHO solution may be added to a microcentrifuge tube and mixed. 25 μL 10% APS may be added and quickly mixed into the solution via tube inversion.

For a 10% (w/v) PNIPAAm hydrogel: 500 μL PNIPAAm stock, 455 μL DI, and 5 μL TEMED may be added to a microcentrifuge tube and mixed. 40 μL 10% APS may be added and quickly mixed into the solution via tube inversion. At room temperature, these volumes of TEMED and APS may yield an initial gel within five minutes and may be used upon mixing.

For a 1.5% (w/v) Ca-ALG hydrogel: 1 mL of the Na-ALG stock may be added to a microcentrifuge tube. To the tube, 0.0045 g CaCO3 (45 mM final concentration) and 0.016 g GDL (90 mM final concentration) may be added sequentially, mixing vigorously after each addition. The solution may be used immediately upon mixing. At room temperature, these amounts of CaCO3 and GDL may take 24 hours to form a complete gel but the viscosity of the solution begins to increase rapidly within 10 minutes as the initial gel begins to form.

For a 12.9% (w/w) PAAm 1.6% (w/w) ALG PAAm-co-Ca-ALG hydrogel: 2.58 mL PAAm-ALG stock, 282 μL DI, 60 μL of 50% glycerol, and 0.3 μL TEMED may be added to a microcentrifuge tube and mixed by tube inversion. To the tube, 0.0039 g CaCO3 and 0.0138 g GDL may be added sequentially to initiate, mixing vigorously after each addition. Working quickly, 75 μL 10% APS may be added to the solution and mixed via tube inversion. The solution may be used immediately.

For 13% (w/v) PNIPAAm 1% PAAm (w/v) PNIPAAm-co-PAAm hydrogel: 650 μL of PNIPAAm stock, 50 μL PAAm stock, 50 μL 50% glycerol, 50 μL ethanol, 145 μL DI, and 5 μL TEMED may be added to a microcentrifuge tube and mixed. 50 μL 10% APS may be added and quickly mixed into the solution via tube inversion. At room temperature, these volumes of TEMED and APS may yield an initial gel within five minutes and may be used upon mixing.

All hydrogel solutions prior to gelation are referred to as precursor solutions.

Gold Nanoparticle (GNP) Synthesis—Gold nanoparticles may be synthesized following various established protocol. Briefly, 20 mL of 1.0 mM HAuCl4 may be brought to a rolling boil in a flask on a stirring hot plate. To the rapidly stirred boiling solution, 2 mL of a 1% trisodium citrate dihydrate may be added to initiate nanoparticle formation through the reduction of the gold (III) in solution. Once the solution turns a deep red, it may be removed from the hot plate and allowed to cool. An approximation of the GNP concentration may be made by measuring the difference between an empty weighing boat and the weighing boat with an air-dried aliquot of the GNP solution then dividing by the volume of the aliquot.

Mold Preparation, Infiltration, and Degradation—UV-cured molds may be filled with 100% EtOH followed by DI and a 10% Tween 20 (BioRad) solution. The molds may be left with the Tween 20 solution for a minimum of one hour before being rinsed with DI and may be used immediately.

Prepped molds may be filled with the hydrogel precursor solution of choice and allowed to gel completely before transferring into DI for 24 hours. The gel-containing molds may be transferred to a conical tube with DI and placed in a heated water bath (PAAm/ALG/PAAm-ALG: 70° C.; PNIPAAm: 50° C.). A conical tube of an HFIP solution may be also placed in the water bath to warm prior to degradation (PAAm/ALG/PAAm-ALG: 50% HFIP diluted with DI; PNIPAAm: 100% HFIP). Once heated, a mold may be transferred to separate conical the along with enough HFIP solution to cover. Mold degradation should be carefully supervised until the gel is mostly released as the degradation time may vary depending on mold complexity. The tube may be removed from the water bath and the HFIP solution may be replaced with DI a minimum of three times to remove the gels from the HFIP environment and to remove remaining mold pieces. Over the course of 24 hours, the DI in the tube may be exchanged with clean DI minimum of three times to leech any remaining HFIP from the solution. After 24 hours, the 3D gel may be ready to use.

Print Resolution and Hydrogel Fidelity—Two-and-a-half dimensional (2.5D) molds with cubic indentations of variable side length may be made to test the accuracy of the 3D printer against the intended CAD design and the fidelity of PAAm hydrogels against the printed mold. The indentation side lengths may vary between 200 μm and 1000 μm at 200 μm intervals. To better visualize the print resolution and hydrogel fidelity, a 3D “donut” with 16 equally spaced, circular ridges present on the donut's surface. The ridges may be 500 μm in width and may be 22.5° apart.

Gel Functionality After Solvent Treatment—PAAm, PNIPAAm, and Ca-ALG gels may be qualitatively gauged for retained functionality (mechanical strength, thermosensitivity, secondary crosslinking respectively) following degradation and DI equilibration. PAAm hydrogel: A square pyramid-like, tubular mold may be filled with PAAm precursor, allowed to gel and equilibrate in DI, and may be degraded according to the PAAm-specific, mold degradation protocol. The resulting gel may be equilibrated in DI before being pressed with a finger. PNIPAAm hydrogel: A cube-like, tubular mold may be filled with PNIPAAm precursor, allowed to gel and equilibrate in DI, and may be degraded according to the PNIPAAm-specific, mold degradation protocol. The resulting gel may be equilibrated in DI before being heated past the lower critical solution temperature (LCST) of PNIPAAm in a water bath. Ca-ALG hydrogel: A sphere-like, tubular mold may be filled with ALG precursor, allowed to gel and equilibrate in DI, and may be degraded according to the ALG-specific, mold degradation protocol. The resulting gel may be equilibrated in DI before undergoing secondary crosslinking by a multivalent cation (Fe) of a higher alginic affinity than Ca²⁺.

Fluidic Operations in 2.5D—A simple 2.5D, Y-shaped mold may be made to characterize different methods of mold infiltration and their resulting hydrogels using the technique. Co-flow: PAAm-co-FOA precursor and PAAm-co-RHO precursor solutions may be simultaneously infiltrated into the mold at equivalent flow rates and gelled completely after the flows inside the mold stabilized. Sequential: PAAm-co-FOA precursor may be infiltrated into one inlet of the mold at a defined flow rate until the mold is filled with solution. A known volume of PAAm-co-RHO precursor may be infiltrated into the other inlet of the mold at the same flow rate after the flow of the PAAm-co-FOA is stopped. Once the volume has fully entered the mold, the solution may gel completely. The volumes of PAAm-co-RHO may be varied to create different sized regions of PAAm-co-RHO in the final gel. Consecutive: PAAm-co-FOA precursor may be infiltrated into one inlet of the mold at a defined flow rate until the mold is filled with solution. A known volume of PAAm-co-RHO precursor may be infiltrated into the other inlet of the mold at the same flow rate immediately after the flow of the PAAm-co-FOA is stopped. A known volume of PAAm-co-FOA precursor may be infiltrated into the same inlet as PAAm-co-RHO to push the PAAm-co-RHO precursor deeper into the mold and encase the PAAm-co-RHO in PAAm-co-FOA. Once the volume had fully entered the mold, the solution gelled completely. The volumes of PAAm-co-RHO may be varied to create different sized regions of PAAm-co-RHO in the final gel. Diffusion: PAAm-co-FOA precursor may be infiltrated into one inlet of the mold at a defined flow rate until the mold is filled with solution. A known volume of PAAm-co-RHO precursor may be added to the other inlet of the mold and mixed using a micropipette (e.g., from Eppendorf) for 0 s, 3 s, and 6 s, respectively, after which the solution may gel completely.

Microfluidic Operations—2.5D molds of a microfluidic herringbone mixer and gravity separator may be 3D printed to gauge the compatibility of this technique with microfluidic operations. Mixer: PAAm-co-FOA precursor and PAAm-co-RHO precursor may be co-infiltrated into a 2.5D, pseudo-microfluidic mixer with dual herringbone-shaped protrusions on the top and bottom of the mold at equivalent flow rates (<0.5 mL/min) and allowed to gel completely after the flows stabilize. The experiment may be repeated in a mold without the herringbone-like protrusions to obtain control samples. Particle Separator: PAAm precursor doped with blue polyethylene microspheres (47-53 μm) may be infiltrated into a 2.5D mold containing an array of square-pyramidal indentations on the bottom of the mold. Precursor flow may be allowed to stabilize before letting the solution gel completely.

Dynamic Mechanical Analysis (DMA)—PAAm, Ca-ALG, and PAAm-co-Ca-ALG type IV dumbbells conforming to the American Standards for Testing and Materials (ASTM) International standards for tensile testing may be made by casting precursor solutions in 3D printed molds of the dumbbell structure. Stress/strain curves for each hydrogel may be obtained using a DMA Q800 (TA Instruments) equipped with a tensile clamp and set with a strain rate of 0.2 mm/min. The following hydrogel compositions were tested: 5% (w/w) PAAm, 7.5% (w/w) PAAm, and 10% (w/w) PAAm; 0.5% (w/v) ALG, 1% (w/v) ALG, and 1.5% (w/v) ALG; 10%/0.5% PAM-co-Ca-ALG. For each hydrogel composition, a subset of the gels may be subjected to a 50% HFIP solution diluted in DI for 11 minutes before being allowed to equilibrate in DI for 24 hours. After DI equilibration, these solvent-treated gels may be tested alongside their control counterparts. All tensile experiments may be taken to failure.

Thermally Induced Water Loss in PNIPAAm—10% (w/v) PNIPAAm blocks (10 mm×10 mm×4 mm) may be made in polydimethylsiloxane (PDMS) molds and placed in a DI bath set to temperatures between 25° C. and 50° C. with 5° C. steps to quantify the water loss percentage at each temperature. The blocks may spend 10 minutes equilibrating at each temperature before measuring the mass of each block using a NewClassic ME Analytical Balance (Mettler Toledo™). The blocks may be returned to the water bath, the temperature may be increased, and the cycle repeated until the final measurements at 50° C. are taken. Two subsets (n=6 each) of the tested blocks were subjected to 100% HFIP for four and eight minutes respectively before being retested for their water loss percentage.

Hydrogel Transparency—The transparencies of hydrogel samples (L: 2 cm; W: 2 cm; H: 2 mm) made of PAAm, Ca-ALG, and PNIPAAm may be characterized before and after solvent exposure. A small circuit comprised of a linear DC voltage regulator, a 9-volt (V) battery, and a white light emitting diode (LED) may be made to provide a consistent light source for the experiment. The samples may be placed in a semi-dark chamber on a glass slide a minimal distance (touching) away from the LED with another glass slide placed on top to reduce light reflection and scattering. The light illuminance passing through the hydrogels may be measured using a REED R8140 LED Light Meter (REED Instruments) and analyzed in MATLAB (MathWorks®).

Functionality Gradients—2.5D molds designed around a 20 mm×4 mm×2 mm bar-like space may be 3D-printed to characterize simple gradients in stiffness, material constituency, dopant concentration, and chemical moiety concentration created from the collision of opposing inflows. Stiffness: Opposing flows of 10% PAAm precursor and 5% PAAm precursor (stiff and soft respectively) may be infiltrated into modified molds with dumbbell-like grips and hemispherical indentations resulting in dumbbell like hydrogels with hemispherical protrusions down the length of the gel. The gels may be placed in a 3D printed stretching fixture and imaged under a microscope in an unstretched state and a stretched state. The displacement between the hemispherical protrusions before and after stretching may be calculated in ImageJ (ImageJ) and plotted using MATLAB. Material: Opposing flows of 10% PAAm precursor and 13%/1% PNIPAAm-co-PAAm precursor may be infiltrated into the 2.5D molds and allowed to gel completely. The gels may be placed between two glass slides with spacers on each end and submerged in a water bath above 40° C. Images taken with a digital single-lens reflex (DSLR) camera (Nikon D3400, Nikon) may be quantified for changes in gray value in ImageJ. Dopant Concentration: Opposing flows of 10% PAAm precursor and 10% PAAm with GNP precursor may be infiltrated into the 2.5D molds and allowed to gel completely. Images taken under a binocular microscope (AMScope™) with a DSLR camera and a microscope camera adapter (AMScope) may be quantified for changes in gray value in ImageJ. Chemical Moiety: Opposing flows of 10% PAAm-co-FOA precursor and 10% PAAm-co-RHO precursor may be infiltrated into the 2.5D molds and allowed to gel completely. Images taken with a fluorescent microscope (Olympus BX-53, Olympus) may be quantified for changes in intensity in ImageJ.

Hydrogel Functionality in 3D—3D fluidic molds may be 3D printed to showcase hydrogel creations made using a combination of the infiltration methods and gradient schemes established herein. Table: A four-legged table with a geometric flower design on the top, inlets above each leg, and an outlet in the center may be 3D printed to highlight stiffness variance within a single structure and 3.5% PAAm precursor was infiltrated into two legs to represent “soft legs” and, before the “soft legs” gelled, 10% PAAm precursor may be infiltrated into the other two of the legs as “stiff legs” and the table-top before gelling completely. Octet-Truss Lattice: An octet lattice mold comprised of seven repeating octet units and two tensile “grips” may be carefully infiltrated with PAAm-co-Ca-ALG precursor and allowed to gel completely before removal of the mold. Flower: A flower mold with an inlet from the top, an inlet from the bottom, and outlets on each “petal” may be made to create an environmentally responsive, hydrogel flower. PAAm-co-FOA precursor may be infiltrated from the top at a flow rate (0.3 mL/min) twice that of the PAAm-co-RHO precursor flowing in from the bottom inlet (0.15 mL/min). After the flow/within the mold stabilized, the solution gelled completely prior to mold removal. Egg: An egg mold with a large inlet encasing a smaller inlet within it may be made to create an egg-shaped hydrogel with an encapsulated, GNP center. 10% PAAm precursor may be infiltrated from the larger inlet until approximately ⅓ of the egg is filled. A known volume of GNP-doped 10% PAAm precursor may be then co-infiltrated alongside the PAAm precursor at an equivalent flow rate until the flow of this solution stopped. The flow of the PAAm precursor may continue until the GNP-doped PAAm region within the mold is fully encapsulated in PAAm. After this occurred, the solution within the egg gelled completely prior to mold removal.

Infrared Thermography—A JANIS VPF-800 vacuum chamber (Lake Shore Cryotronics) may be utilized for housing the sampled, and an Edwards T-station 75 turbopump may be to maintain a vacuum level below 10-5 Torr (high vacuum range) for each sample measurement. The samples may be positioned in the vacuum changer with a custom polydimethylsiloxane (PDMS) container and loosely wrapped with an IR-transparent low-density polyethylene (LDPE) film. The sample may be imaged with an IR camera (FLIR A655sc with a 25 μm pixel resolution macro-lens, FLIR) through the vacuum chamber's ZnSe window. Laser-heating may be applied to the center of the samples for 20 minutes with a 125 mW, 532 nm laser (Big Lasers). Variations in pixel temperature across the sample may be normalized by subtracting the laser off-state temperature distribution from the laser on-state distribution.

Although specific methods and design considerations are discussed above, any of a variety of methods and designs considerations as appropriate to the requirements of a specific application can be utilized in accordance with embodiments of the invention. While the above description contains many specific embodiments of the invention, these should not be construed as limitations on the scope of the invention, but rather as an example of one embodiment thereof. It is therefore to be understood that the present invention may be practiced otherwise than specifically described, without departing from the scope and spirit of the present invention. Thus, embodiments of the present invention should be considered in all respects as illustrative and not restrictive.

What is claimed is:

1. A method for generating three-dimensional (3D) hydrogels, the method comprising:
generating a fluidic mold;
infiltrating the fluidic mold with a precursor solution;
gelatinizing the precursor solution; and
degrading the fluidic mold in a degradation solution to release a 3D hydrogel.

2. The method of claim 1, wherein the fluidic mold is generated using a 3D printing process.

3. The method of claim 2, wherein the 3D printing process is 3D sterolithography.

4. The method of claim 2, wherein the 3D printing process utilizes acrylonitrile butadiene styrene (ABS) resin.

5. The method of claim 1 further comprising pretreating the fluidic mold with a low surface tension solution prior to infiltration.

6. The method of claim 1, wherein the precursor solution comprises a natural, synthetic, or “smart” solution.

7. The method of claim 1, wherein the precursor solution is doped using nanomaterials or biomolecules.

8. The method of claim 1, wherein the degradation solution is a water-miscible solvent.

9. The method of claim 1, wherein degrading the fluidic mold further comprises adjusting a temperature associated with the degradation of the fluidic mold to minimize concentration of the degradation solution or exposure time to the degradation solution.

10. The method of claim 1, wherein the 3D hydrogel is released with minimal to no change to the 3D hydrogel's basic physical behavior.

11. The method of claim 1, wherein the precursor solution comprises polyacrylamide (PAAm), poly(n-isopropylacrylamide) (PNIPAAm), or calcium alginate (Ca-ALG).

12. The method of claim 1, wherein the fluidic mold comprises at least one inlet.

13. The method of claim 12, wherein the fluidic mold further comprises at least one outlet and infiltrating the fluidic mold further comprises infiltrating the fluidic model via diffusion where the precursor solution enters via the at least one inlet and exits via the least one outlet.

14. The method of claim 1, wherein the fluidic mold comprises a plurality of inlets.

15. The method of claim 14, wherein infiltrating the fluidic mold further comprises co-flowing a first precursor solution via a first inlet and a second precursor solution via a second inlet.

16. The method of claim 14, wherein infiltrating the fluidic mold further comprises sequential flowing a first precursor solution via a first inlet and a second precursor solution via a second inlet.

17. The method of claim 14, wherein infiltrating the fluidic mold further comprises consecutive flowing a first precursor solution via a first inlet and then a second precursor solution via a second inlet.

18. The method of claim 17, wherein infiltrating the fluidic mold further comprises consecutive flowing a third precursor solution via the second inlet.

19. The method of claim 1, wherein the 3D hydrogel is programmed for function including motion/mechanics, temperature/light interactivity, or gradient behavior.

20. The method of claim 1, wherein the 3D hydrogel is multi-material, multi-functional, with flow-defined heterogeneity.
